(19) United States
(12) Patent Application Publication
(10) Pub. No.: US 2025/0352888 A1
(43) Pub. Date: Nov. 20, 2025

(54) Attachable Mic Device for Gaming Controller (Xbox, PS5, etc.)

(71) Applicant: Brandon Christian Mellergaard, Ellensburg, WA (US)

(72) Inventor: Brandon Christian Mellergaard, Ellensburg, WA (US)

(21) Appl. No.: 19/014,285

(22) Filed: Jan. 9, 2025

Related U.S. Application Data
(60) Provisional application No. 63/648,153, filed on May 15, 2024.

(51) Int. Cl. A63F 13/215; A63F 13/213; G06F 3/039; G06F 3/16; H04R 1/02; H04R 1/08

(52) U.S. Cl. CPC A63F 13/215; A63F 13/213; G06F 3/039; G06F 3/167; H04R 1/026; H04R 1/028; H04R 1/083; A63F 2300/1043; A63F 2300/1081; H04R 2430/01; H04R 2499/11

(57) ABSTRACT

An accessory (108) for a gaming controller (102) is disclosed. The accessory (108) is configured to improve the functionality of the gaming controller (102) during a user's interaction with various interactive programs, including virtual gaming, image/video editing, software testing, and the likes. The accessory (108) includes built-in speaker (110), microphone (112) and Push-to-Talk (PTT) panel (118). The PTT panel (118) is located on an exterior surface of the accessory (108), through actuation of which users can effortlessly communicate with teammates or opponents during a gaming session. The accessory (108) is adapted to effectively prevent any contact with the hands of the user, when the user is gripping the gaming controller (102) in his/her hands. The accessory (108) improves ergonomics of the gaming controller (102). The accessory (108) is designed to ensure that the user's handling of the gaming controller (102) is not impeded in any manner.

### CROSS REFERENCE

This non-provisional application claims the benefit under 35 U.S.C. § 119(e) of U.S. Provisional Patent Application Ser. No. 63/648,153, entitled “Attachable Mic for Gaming Console (Xbox, PS5, etc.)”, filed on 15 May 2024.

### TECHNICAL FIELD

The present disclosure relates to gaming controllers for interfacing with interactive programs. In particular, the present disclosure pertains to an accessory for a gaming controller configured to enhance utility of said gaming controller during interaction of a user with an interactive program, such as virtual gaming, image/video editing, software testing, and the like.

### BACKGROUND

The video game industry has undergone significant transformations over time. With the continuous expansion of computing capabilities, game developers have capitalized on these advancements by crafting software that harnesses the enhanced computing power. In pursuit of this goal, developers have been integrating complex operations and mathematical algorithms into games to deliver highly immersive and lifelike gaming experiences.

Example of gaming platforms includes devices like the Sony Playstation®, Sony Playstation4® (PS4), Sony Playstation5® (PS5), Xbox 360, Xbox One, Xbox Series S and Xbox Series X, all available as gaming consoles. As widely recognized, these consoles are intended for connection to a display device, typically a television or a monitor, facilitating user engagement through handheld controllers. A notable instance of such a controller is the Xbox wireless controller produced by Microsoft Gaming Inc.

During multiplayer online gaming sessions, whether on a personal computer or a dedicated video game console, there's often a desire to communicate verbally or via video with other players located remotely who are concurrently engaged in the same online game. Conventional video game controllers lack built-in features for such verbal communication, necessitating the use of external microphone and speaker devices. These devices typically involve wearing a headset, comprising a microphone and either a headphone or earphone. However, wearing a headset for extended periods can be uncomfortable and may restrict the user's movements. Additionally, the need for occasional readjustment during gameplay further detracts from the optimal gaming experience. Cumulatively, these factors contribute to a less-than-ideal environment for enjoying online games.

Currently available external microphone and speaker devices are known to impose limitations on users' ability to speak freely and without constraints. Such devices usually obstruct a user's capacity to handle a gaming controller comfortably due to presence of intrusive components. These devices are frequently reported as uncomfortable, restrictive, and cumbersome for prolonged gaming sessions. Moreover, functionalities associated with the conventional microphone and speaker devices often include a limited volume control, typically offering only volume adjustment and a mute function. Additionally, such devices lack advanced background noise cancellation capabilities, resulting in users being subjected to unwanted environmental noise during gaming sessions due to microphones of such devices remaining constantly active.

Hence, there exists a requirement within the field for an efficient, reliable, and economical solution that addresses the drawbacks, limitations, and deficiencies of conventional gaming controllers and external microphone and speaker devices associated thereto.

### OBJECTS OF THE PRESENT DISCLOSURE

An object of the present disclosure is to provide an accessory of a gaming controller connected to a gaming console or a personal computer, configured to improve utility of gaming controller as well as convenience of a user of the gaming controller.

Another object of the present disclosure is to provide an accessory of a gaming controller capable of improving communication effectiveness between multiple users engaged in a gaming session.

Another object of the present disclosure is to provide an accessory of a gaming controller, which is designed to enable efficient utilization of fingers of the user, when the user wraps his/her hands around the gaming controller with the accessory attached thereto.

Another object of the present disclosure is to provide an accessory of a gaming controller, designed to effectively prevent any contact with the hands of the user, when the user is gripping palm support regions or grips of the gaming controller in his/her hands.

### SUMMARY

Currently available microphones are uncomfortable, and restrictive to comfortability of users engaged in a gaming session using a gaming controller connected to a gaming console or a personal computer (PC). They also do not provide an easy way for an individual to adjust their volume settings directly from their gaming controllers.

The present disclosure provides an accessory for the gaming controller capable of providing the user with the ability to efficiently communicate with other users through the gaming console/PC. The accessory is adapted to be attached to the gaming controller, and includes in-built microphone and speaker for communication. The accessory is adapted to connect to the gaming controller and offers a five-feature volume control set that allows a user to seamlessly take control of the microphone and speaker that is integrated into the accessory. The accessory is equipped with a push-to-talk (PTT) panel/pad positioned underneath the accessory, and extending underneath a bottom surface of the gaming controller. The PTT panel allows the users to effortlessly control when they want to talk or chat with other users engaged in gaming sessions.

In an aspect, the present disclosure provides an accessory for a gaming controller. The accessory includes one or more speakers configured to generate audio based on receipt of electrical signals from the gaming controller, when the accessory is connected to the gaming controller through an input serial interface. The accessory includes at least one in-built microphone configured to transmit voice-related audio to an audio transmitter of the gaming controller, to enable a primary user to communicate with one or more secondary users located remotely while the primary user engages in interactive programs through the gaming controller.

The accessory also includes a built-in video camera configured to capture a video footage of the primary user engaging in the interactive programs through the gaming controller, and transmit the captured video footage to a computing device to which the gaming controller is connected. The accessory is equipped with a Push-to-Talk (PTT) panel located on an exterior surface of a housing of the accessory. The PTT panel is positioned at a bottom portion of the housing such that the PTT panel emanates outwards from the bottom portion of the housing. The PTT panel is operatively connected to the one or more speakers and the at least one in-built microphone, and configured to control the one or more speakers and the at least one in-built microphone to selectively regulate generation of the audio by the one or more speakers, and enable or disable transmission of the voice-related audio to the audio transmitter of the gaming controller. The accessory also includes a plurality of keys, each adapted to control actuation of any or a combination of the one or more speakers, the at least one built-in microphone, built-in video camera and the PTT panel.

In an embodiment, the computing device may be connected to a display device configured to display the captured video footage transmitted to the computing device by the built-in video camera.

In an embodiment, the accessory may include a port for connecting an external video camera to the computing device to which the gaming controller is connected.

In an embodiment, the housing may be adapted to accommodate the one or more speakers, the at least one in-built microphone and the built-in video camera. The housing may have a profile that seamlessly integrates with a shape of the gaming controller to provide unrestricted hand placement when the primary user holds the gaming controller.

In an embodiment, the at least one built-in microphone may be configured to capture the voice-related audio from the primary user, convert the voice-related audio into electrical signals, and transmit the converted electric signals to the audio transmitter of the gaming controller. The audio transmitter of the gaming controller may be configured to transmit the converted electrical signals to any of the computing device for storage, and a secondary computing device associated with the one or more secondary users.

In an embodiment, the PTT panel may be operatively connected to the at least one built-in microphone to control activation of the at least one built-in microphone, and operatively connected to the one or more speakers to control generation of the audio from the one or more speakers with reduced volume, upon actuation thereof by the primary user. The PPT panel offers the primary user to control the built-in microphone, in such a way that upon actuation by the primary user, the PTT panel will activate the at least one built-in microphone to allow the transmission of voice related audio through the accessory across the gaming controller, and through the gaming console to another user that is on a different gaming console.

In an embodiment, the accessory may be equipped with a serial interface to enable the accessory to be operatively coupled with external devices.

In an embodiment, the housing may be adapted to be flush with one or more surfaces of the gaming controller, and may include at least a pair of side portions having any or a combination of curved profiles, convex profiles, and concave profiles adapted to prevent contact with the hands of the primary user, when the user grips palm support regions of the gaming controller.

In an embodiment, the housing may incorporate an inward design directing away from the palm support regions of the gaming controller, to prevent contact with the, when the gaming controller 102 is held by the primary user.

In an embodiment, the accessory may be equipped with a voice-based processing system configured to enable the primary user to speak verbal commands into the at least one built-in microphone, to trigger one or more functions of any of the gaming controller and the computing device based on the verbal commands.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary schematic representation of a gaming controller connected to a personal computer or a gaming console for allowing a user to play a virtual game, in accordance with an embodiment of the present disclosure;

FIGS. 2A to 2D illustrate various exemplary representations of an accessory for improving utility of the gaming controller, in a first configuration, in accordance with an embodiment of the present disclosure;

FIGS. 3A to 3C illustrate various exemplary representations of the accessory, in a second configuration, in accordance with an embodiment of the present disclosure; and

FIGS. 4A to 4C illustrate various exemplary representations of the accessory connected to an expansion port of the gaming controller, in accordance with an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

Embodiments explained herein relate to an accessory designed for a gaming controller, aimed at improving the functionality of the gaming controller while a user engages with an interactive program, such as virtual gaming, image/video editing, software testing, and similar activities.

Conventionally, gaming controller, especially Xbox controller, are required to be connected to headsets that are usually bulky, uncomfortable, and can become bothersome when worn for extended periods. The proposed accessory of the present disclosure offers a hassle-free communication experience during gaming sessions of a user by eliminating the need to wear or interact with a separate microphones/headsets, allowing users to maintain full freedom of movement during the gaming sessions. The accessory is designed to seamlessly integrate with gaming controllers, such as Xbox controllers, Playstation Controllers, Nintendo Controllers, and the like, to ensure that the fingers and hands of the user are never impeded during the gaming sessions.

Wearing a headset can be cumbersome in social situations as it blocks out surrounding sounds. The proposed accessory enables communication with both online friends and those nearby by eliminating the requirement of external headsets to be connected to the gaming controller. Moreover, the accessory facilitates interaction with individuals physically present with the user while also allowing awareness of environmental sounds like doorbell, dishwasher, or a baby in the background, during gaming sessions of the user. The accessory is designed to balance the ability to hear in-game audio and communications with the flexibility of being aware of surroundings, a feature lacking in conventional headsets that completely encase the ears of the user and block external noise.

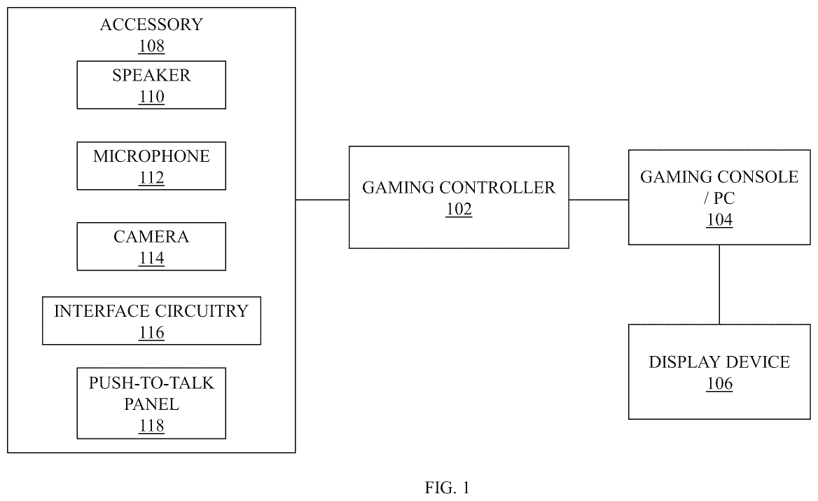

FIG. 1 illustrates a schematic representation of a gaming controller 102 connected to a computing device 104, such as a personal computer (PC), a gaming console, a handheld gaming device, and the like, that allow a primary user to play a virtual game. The gaming controller 102 may be connected to a standard controller port on the game console 104 in the case of a dedicated gaming console. Alternatively, the gaming controller 102 could be connected to any other compatible parallel or serial ports available on a personal computer or dedicated gaming console. The gaming console 104 may be connected to a display device 106, such as a monitor, a television, a projection screen, a portable display, etc., capable of presenting graphics and video content of the video game to the primary user. The gaming controller 102 may take various forms such as a control pad, a steering wheel, a gun, a joystick, a mouse, a keyboard, or any other suitable input device/peripheral for video gaming.

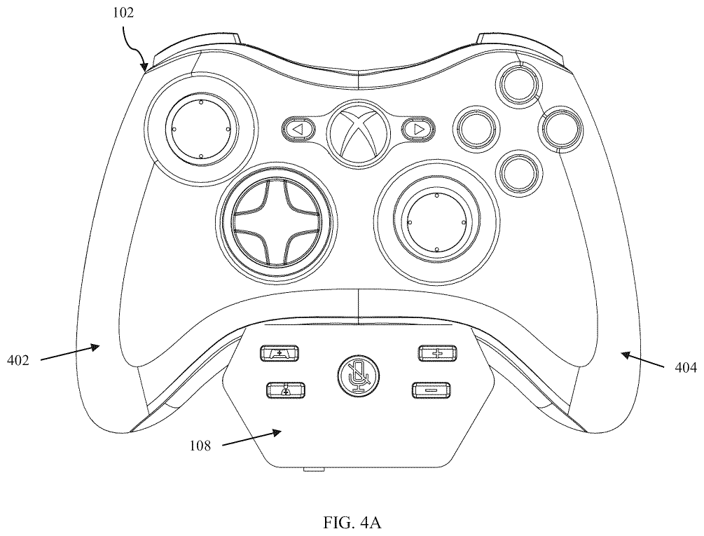

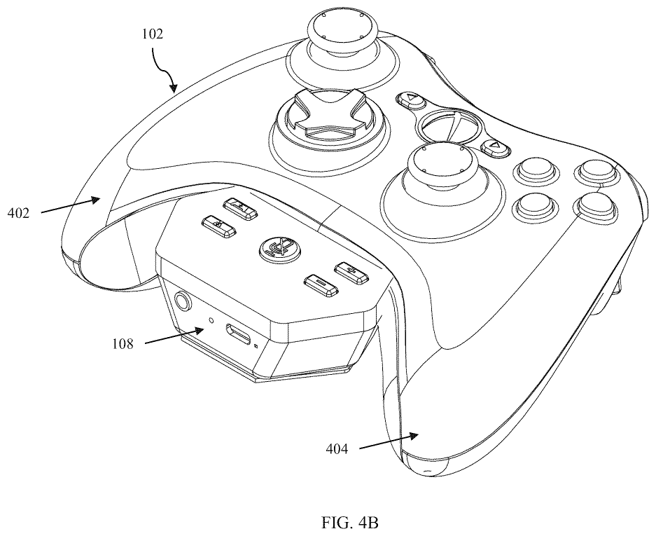

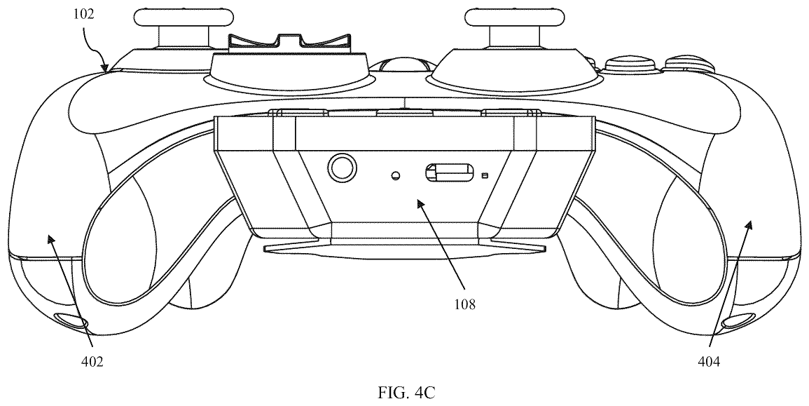

The gaming controller 102 may include a plurality of keys, manipulation of which by a primary user can result in actions of one or more entities/avatars in the virtual game. The gaming controller 102 also includes two separate palm support portions (as shown in FIG. 4A), each adapted to support a palm of a hand of the primary user, when the primary user is holding the gaming controller 102 in his/her hands. The gaming controller 102 may include an expansion port (not shown) equipped with a serial interface, such as Universal Serial Bus (USB) interface, micro-USB interface, USB-C interface and the like, to allow the gaming controller 102 to communicate with external devices like microphones, chargers, mice, keyboards, printers, accessories, and the likes.

The gaming controller 102 can be connected to an external accessory 108 through the expansion port. The accessory 108 may include one or more built-in speakers 110 and at least one microphone 112. The speaker 110 and the microphone 112 may be incorporated directly into the design of the accessory 108. As a result, the accessory 108 allows the primary users to communicate with other secondary players located remotely while engaging in online games, when the accessory 108 is connected to the gaming controller 102. Consequently, the primary users can communicate with fellow online gamers without the need for wearing cumbersome headsets or being inconvenienced by dangling wires. Additionally, the accessory 108 relieves the primary users from managing external microphones or speakers that may be linked to the game console and/or externally provided to the gaming controller 102, which could obstruct or severely affect gaming experience of the primary user. The accessory 108 may also is equipped with a built-in video camera 114, which could be a digital video camera. This camera can capture video footage of the primary user interacting with the gaming controller 102 or other scenes and transmit them via an interface circuitry 116 to the gaming console 104. The built-in video camera 114 may be configured to capture the video footage of the primary user engaging in the interactive programs through the gaming controller 102, and transmit the captured video footage to the computing device 104 to which the gaming controller (102) is connected. The captured video images could then be displayed on the display device 106 for the primary user's viewing, stored in the memory of the game console 104, and/or transmitted to remote game consoles for viewing by players at those remote consoles. Additionally or alternatively, in other configurations, the accessory 108 may be equipped with a port for connecting an external video camera output, either instead of or in addition to the integrated video camera.

The accessory 108 is designed to seamlessly integrate with the gaming controller 102 to provide unrestricted hand placement when the primary user wraps his/her hands around the gaming controller 102, ensuring that the gaming experience of the primary user is not disrupted in any matter while the primary user is holding the gaming controller 102 in his/her hands. The accessory 108 is equipped with the built-in speaker 110 and microphone 112, negating the necessity for an external headset during gaming sessions. The speaker 110 may be interfaced with a Natural language model, such as Alexa™, Bixby™, Siri™, Bard™, and other Large language models, to improve communication effectiveness of the gaming controller 102. The built-in microphone 112 may be configured to transmit voice-related audio to an audio transmitter of the gaming controller 102. The built-in microphone 112 may be configured to capture audio from the primary user and convert the audio into electrical signals, which can be transmitted through the accessory 108 into the gaming controller 102 and across the gaming console/PC 104 to another gaming console, where it is received by the secondary user. The speaker 110 may be configured to generate audio based on receipt of electrical signals from the gaming controller 102, when the accessory 108 is connected to the gaming controller 102. The speaker 110 converts the electronic signals back into audio, enabling the primary users with the accessory 108 to hear the transmitted audio.

In an exemplary embodiment, the built-in microphone 112 may be configured to capture the voice-related audio from the primary user, convert the voice-related audio into electrical signals, and transmit the converted electric signals to the audio transmitter of the gaming controller 102. The audio transmitter of the gaming controller 102 may be configured to transmit the converted electrical signals to any of the computing device 104 for storage, and a secondary computing device associated with one or more secondary users.

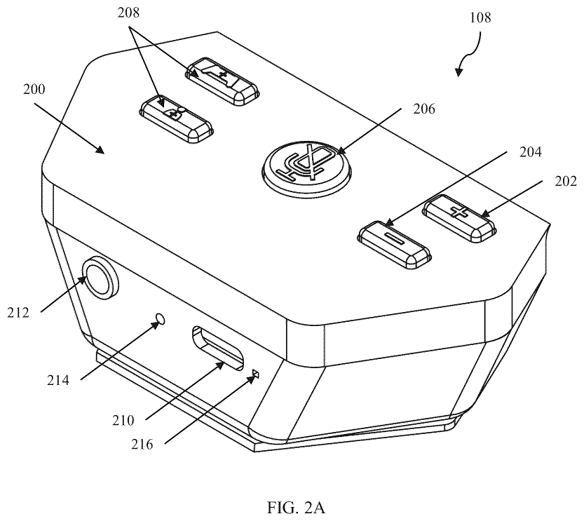

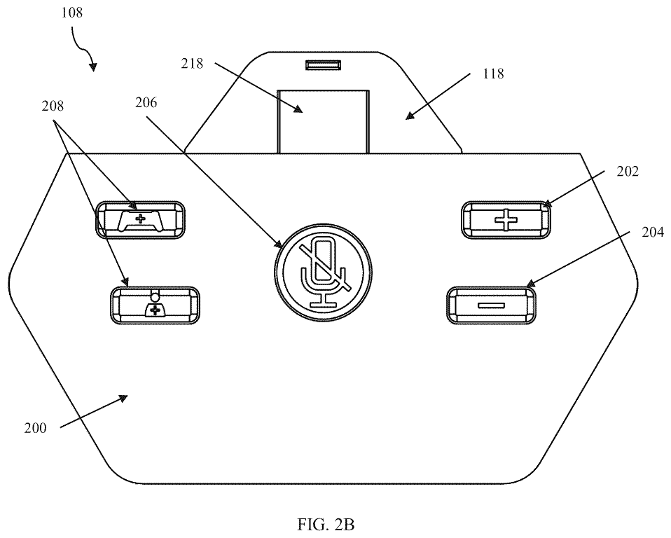

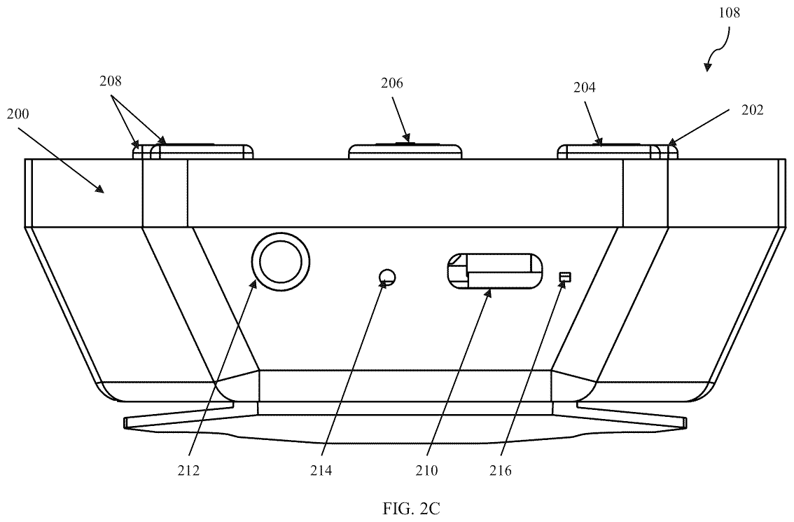

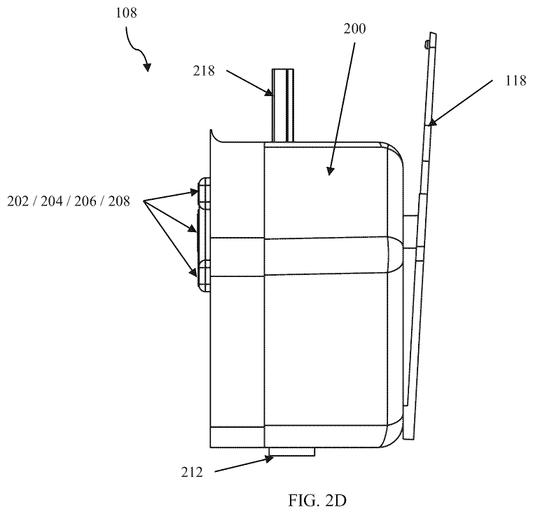

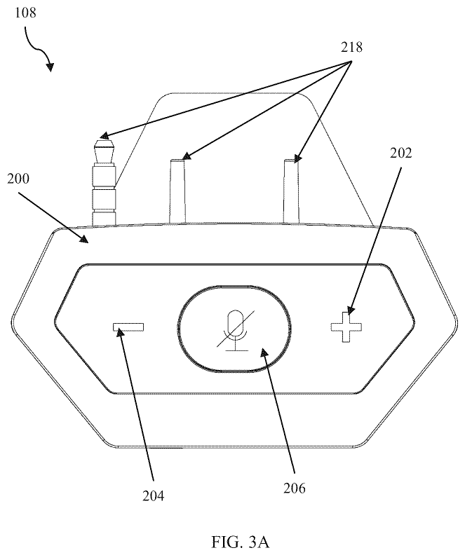

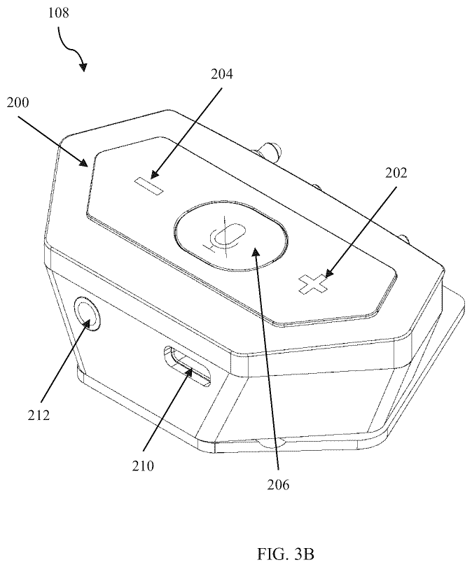

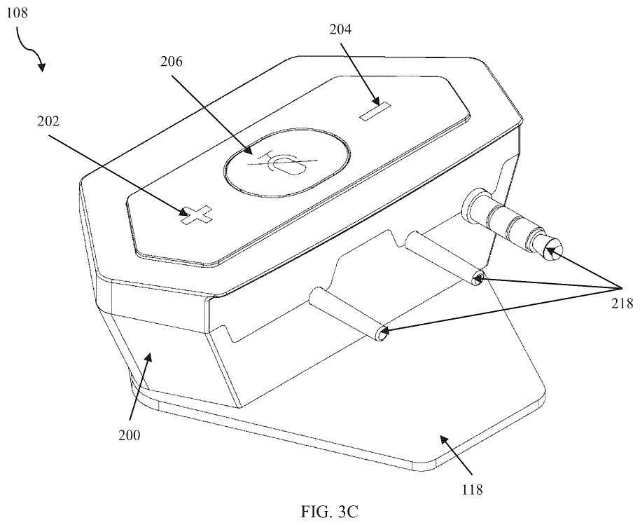

The accessory 108 also includes a PTT panel 118, as clearly shown in FIGS. 2B, 2D and 3C, located on an exterior surface of the accessory 108, through actuation of which players can effortlessly communicate with teammates or opponents while playing. The PTT panel 118 may be located beneath the accessory 108 to provide easy access to the primary user, while allowing efficient utilization of little, ring, or middle fingers of the primary user, when the primary user wraps his/her hands around the gaming controller 102 with the accessory 108 coupled thereto. The accessory 108 is designed to be small and fit perfectly with the gaming controller 102 so as to not hinder mobility the primary user while using the gaming controller 102. The PTT panel 118 is adapted to control actuation of the speaker 110 and the microphone 112 of the accessory 108, such that the PTT feature serves two main functions, i.e., allowing the primary users to control when they speak while blocking out unwanted background noise to ensure clear communication. In an example, once the PTT panel 118 is pressed by the primary user, the microphone 112 automatically gets activated and volume of the audio output emanating from the speaker 110 volume decreases automatically.

To activate the built-in microphone 112, the primary user simply needs to press the PTT panel 118 located underneath the accessory 108. The PTT panel 118 may extend outward and smoothly integrates beneath the gaming controller 102 for optimal accessibility. Covering the bottom area of the gaming controller 102, the extended PTT panel 118 allows the primary user to press anywhere on its surface to engage the microphone 112. Utilizing the PTT feature with the panel 118 on the underside of the accessory 108, the PTT feature can be activated with any of the fingers of the primary user wrapped around the gaming controller 102. The primary user can simply press/push the PTT panel 118 on the bottom of the accessory 108 to selectively enable or disable communication, while ensuring that any unwanted noise does not transmit through the microphone 112, thereby preventing any hindrance to communication between the primary user and his/her peers. By automatically muting the microphone 112 when the PTT panel 118 is not activated, the accessory 108 prevents any unintended noise transmission. Consequently, the accessory 108 offer the users/gamers a more convenient communication solution, eliminating the discomfort of conventional headsets while maintaining excellent audio quality during gaming sessions.

In an exemplary embodiment, the PTT panel 118 may be operatively connected to the microphone 112 to control activation thereof. The PTT panel 118 may also be operatively connected to the speakers 110 to control generation of the audio from the speakers 110 with reduced volume, upon actuation of the PTT panel 118 by the primary user. The PPT panel 118 offers the primary user to control the built-in microphone 112, in such a way that upon actuation by the primary user, the PTT panel 118 will activate the microphone 118 to allow the transmission of voice related audio through the accessory 108 across the gaming controller 102, and through the gaming console 104 to another user that is on a different gaming console.

Referring to FIG. 2A, where a perspective view of the accessory 108, in a first configuration, is shown. The accessory 108 may include a housing 200 for accommodating the speakers 110, the microphone 112 and the PTT panel 118. The housing 200 has a profile that seamlessly integrates with a shape of the gaming controller 102 to provide unrestricted hand placement when the primary user holds the gaming controller 102. The PTT panel 118 may be located on an exterior surface of the housing 200, such that the PTT panel 118 is positioned at a bottom portion of the housing 200, and configured to control the one or more speakers 110 and the at least one in-built microphone 112 to selectively regulate generation of the audio by the one or more speakers 110, and enable or disable transmission of the voice-related audio to the audio transmitter of the gaming controller 102. The accessory 108 also includes a plurality of keys/buttons, each adapted to control a specific function of any or a combination of the speaker 110, the microphone 112, the camera 114 and the PTT panel 118. The keys may be appropriately positioned on an exterior surface of the housing 200 located near the gaming controller's thumb sticks, such that the keys are readily available for pressing by the primary user when the primary user is holding the gaming controller 102 in his/her hands. In an implementation, the accessory 108 may include keys 202 and 204 on the exterior surface thereof for controlling volume emanating from the in-built speaker 110. The primary user may press the keys 202 and 204 to either increase or decrease the volume of the in-built speaker 110. The accessory 108 may also include a mute key 206 adapted to disable transmission of audio through the microphone 112, when pressed. The mute key 206 may be equipped with a lighting device, such as a Light Emitting Diode (LED), to indicate when the mute key 206 is actuated/in operation. Additional keys 208 may be provided on the exterior surface of the accessory 108 to provide additional control over different operations of the gaming controller 102 or the gaming console 104. For example, the additional keys 208 may enable the primary user to toggle a game chat function and/or a party chat function of the gaming controller 102. These additional keys 208 may assist options for party chat and game chat mix, allowing users to adjust their accessory's speaker audio to prioritize either party chat or game chat.

The accessory 108 may also include a serial interface 210, such as Universal Serial Bus (USB) interface, micro-USB interface, USB-C interface and the like, to allow the accessory 108 to be operatively coupled with external devices like microphones, chargers, mice, keyboards, printers, accessories, and the likes, and an audio port 212, such as a 3.5 mm headphone jack, for enabling connection of external headsets or microphones to the gaming controller 102, as and when required. The audio port 212 enables the primary user to connect wearable headset to the gaming controller 102 for convenient volume control directly from the accessory 108. This unique capability serves a dual purpose, i.e., enabling communication with peers without the need for a headset and it allows the primary user to manage their wearable headset's volume settings directly from the accessory 108 connected to the gaming controller 102, thereby enhancing gaming communication experience of the primary user. In an example, audio emanating from the built-in microphone 112 and the speaker 110 may switch automatically, and get routed to an external headset once the same is plugged into the audio port 212. In an example, when an external headset is plugged into the audio port 212, the user may be able to increase or decrease their microphones headset volume by using volume control keys 202, 204 or mute key 206 of the accessory 108, to control their headsets volume settings. Additionally, the accessory 108 may be equipped with a rechargeable battery and can be conveniently charged using the serial interface 210. An exterior surface of the accessory 108 may also include a speaker outlet 214 for providing a passage for audio output of the built-in speaker 110 to be transmitted towards the primary user, and a microphone inlet 216 to provide a passage for user speech/audio to be transmitted to the microphone 112.

In an exemplary embodiment, the accessory 108 may be equipped with a communication unit designed to wirelessly connect the speakers 110, microphone 112, and other components to external devices such as additional microphones, chargers, mice, keyboards, printers, accessories, and similar devices. The communication unit may include a transceiver that allows wireless connectivity to these external devices via technologies such as Bluetooth, Wireless Fidelity (Wi-Fi), or other comparable communication standards. Once the external device(s) are wirelessly connected to the transceiver, the audio output from the built-in microphone 112 and speaker 110 may automatically switch and be routed to the external devices. For example, a wireless headset could connect to the accessory 108 through Bluetooth connectivity. Once connected, audio from the accessory 108 automatically switches to the wireless headset, and the audio may then be transmitted through the wireless headset. When the wireless headset is connect to the accessory 108, a user has the ability to control volume of the wireless headset with the buttons/keys 202, 204, 206 and 208 that are located on the accessory 108 so that the user can increase, decrease or mute the volume of the wireless headset. This seamless transition is designed to enhance the convenience and flexibility for the primary user, ensuring that audio communication is directed to the most appropriate device for the current gaming session or user requirements.

In an exemplary embodiment, the communication unit of the accessory 108 may be configured to receive an input from the user that determines whether to enable or disable the actuation of the PTT panel 118 when external devices are connected to the accessory 108, either through a wireless or wired configuration. Based on this input, the communication unit selectively enables or disables the muting of the external devices. The muting remains in effect until the primary user manually actuates or presses the PTT panel 118, allowing them to control when the audio from the external devices is unmuted, and when the audio is to be transmitted.

FIGS. 2B and 2C illustrate a plan view and a front view of the first configuration of the accessory 108. FIG. 2D shows a side view of the first configuration of the accessory 108. FIGS. 3A to 3C show various representations of the accessory 108, in a second configuration. The accessory 108 may be equipped with an input serial interface 218, including any or a combination of conductive nose pins, Universal Serial Bus (USB) interface, micro-USB interface, USB-C interface, 3.5 mm jack, and the like, corresponding to the expansion port of the gaming controller 102 to enable the accessory 108 to be connected to the gaming controller 102, as and when required by the primary user. The accessory 108 provides a distinctive two-way communication system that activates when the PTT panel 118 is pressed. The PTT panel 118 may be present at the bottom portion of the housing 200 in the form of a flapper or pivoting element, as clearly shown in FIG. 4C. When the microphone 112 is engaged, the speaker 108 significantly reduces its volume, enabling the primary user to communicate with secondary users across the gaming console 104. Simultaneously, the accessory 108 allows the secondary users to communicate with the primary user of the accessory 108 in a seamless two-way exchange, ensuring uninterrupted communication. The reduction in volume of the speaker 110 enhances the effectiveness of the noise cancellation features integrated into the built-in microphone 112.

FIGS. 4A and 4B illustrate a plan view and a perspective view of the accessory 108 connected to the expansion port (not shown) of the gaming controller 102. FIG. 4C shows a front view of the accessory 108 connected to the expansion port (not shown) of the gaming controller 102. As shown, the accessory 108 may be connected to the gaming controller 102 by physical connection of the input serial interface 218 with the expansion port of the gaming controller 102. The accessory 108 may have a three-dimensional (3D) shape designed so as to prevent any kind of obstruction to hands of the primary user, when connected to the gaming controller 102. In an example, the primary user may hold the gaming controller 102 in his/her hands by gripping the palm support portions 402, 404 of the gaming controller 102. The accessory 108 may be designed to be flush with one or more surfaces of the gaming controller 102, such that when the accessory is connected to the gaming controller 102, the primary user is not easily able to distinguish structural differences between the accessory 108 and said surfaces of the gaming controller 102.

In an exemplary embodiment, the housing 200 is adapted to be flush with one or more surfaces of the gaming controller 102. The housing 200 includes at least a pair of side portions having any or a combination of curved profiles, convex profiles, and concave profiles adapted to prevent contact with the hands of the primary user, when the primary user is gripping the palm support regions 402, 404 of the gaming controller 102 in his/her hands. The housing 200 is also designed taking into account weight distribution of the gaming controller 102. As a result, the accessory 108, when connected to the gaming controller 102, improves ergonomics of the gaming controller 102.

The accessory 108 is designed to ensure that the user's handling of the gaming controller 102 is not impeded in any manner. The accessory 108 attaches to a backport (expansion port) of the gaming controller 102 and extends outward, and the housing 200 features an inward design that directs away from the palm support regions 402, 404 of the gaming controller 102. The housing 200 of the accessory 108 effectively avoids contact with the palm support regions 402, 404 of the gaming controller 102, enabling the users to comfortably wrap their hands around the gaming controller's 102 grips (palm support regions 402, 404) without any obstructive material in the way.

The accessory 108 operates on a plug-and-play model, enabling it to be instantly usable and effortlessly integrated into the gaming controller 102 without requiring additional setup. By eliminating the need for an external headset, the accessory 108 caters to users who prefer a more convenient and unobstructed gaming experience. Designed with casual gamers in mind, the accessory 108 facilitates seamless interaction and communication with friends during gaming sessions. The accessory 108 may incorporate a voice-based processing system that includes a Natural Language Model or voice-activation assistant, such as Amazon Alexa™, Google Assistant™, or similar technologies. The voice-based processing system allows users to issue verbal commands through the microphone 112, which are then transmitted to the operating system. The commands are processed by the system to trigger various functions within the gaming console 104, allowing users to control their console using voice commands. For example, if a primary user says, “Go to Netflix” or “Look up Tom Brady highlights on YouTube,” the corresponding voice command is first captured by the microphone 112. The voice input is then processed by the voice-based processing system, which is supported by a Natural Language Model or a voice assistant. The voice-based processing system interprets the spoken command and triggers the appropriate action. Specifically, it sends a command to the controller 104, which, in turn, communicates with the gaming console 104. The gaming console 104 then executes the appropriate action, and displays the result on the display device 106, such as opening the Netflix app or showing the requested YouTube content. Additionally, the voice-based processing system may be configured to generate automatic responses to spoken commands or queries from the primary user. For example, if the primary user says, “How do you pass level 5 on Skyrim?”, the corresponding command would be captured by the microphone 112. This command is processed by the voice-based system, aided by the Natural Language Model or voice assistant. The voice-based processing system may be configured to either display a response on the display device 106 or provide an audible answer through the speaker 110, enhancing the user experience.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides an accessory of a gaming controller connected to a gaming console or a personal computer, configured to enhance functionality of the gaming controller and improve user experience.

The present disclosure provides an accessory of a gaming controller capable of enhancing communication effectiveness between multiple users engaged in a gaming session.

The present disclosure provides an accessory of a gaming controller specifically crafted to optimize the user's finger usage. This is achieved when the user wraps their hands around the gaming controller with the accessory attached.

The present disclosure provides an accessory of a gaming controller, designed to effectively prevent any contact with the hands of the user, when the user is gripping palm support regions or grips of the gaming controller in his/her hands.

The present disclosure provides an accessory of a gaming controller that is designed with a Push-To-Talk panel that allows a user to control when audio is transmitted through a microphone that is built into the accessory.

1. An accessory (108) for a gaming controller (102), the accessory (108) comprising:
one or more speakers (110) configured to generate audio based on receipt of electrical signals from the gaming controller (102), when the accessory (108) is connected to the gaming controller (102) through an input serial interface (218);
at least one in-built microphone (112) configured to transmit voice-related audio to an audio transmitter of the gaming controller (102), to enable a primary user to communicate with one or more secondary users located remotely while the primary user engages in interactive programs through the gaming controller (102);
a built-in video camera (114) configured to capture a video footage of the primary user engaging in the interactive programs through the gaming controller (102), and transmit the captured video footage to a computing device (104) to which the gaming controller (102) is connected;
a Push-to-Talk (PTT) panel (118) located on an exterior surface of a housing (200) of the accessory (108), the PTT panel (118) being positioned at a bottom portion of the housing (200) and configured to control the one or more speakers (110) and the at least one in-built microphone (112) to selectively regulate generation of the audio by the one or more speakers (110), and enable or disable transmission of the microphone (112) voice-related audio to the audio transmitter of the gaming controller (102); and
a plurality of keys (202, 204, 206, 208), each adapted to control actuation of any or a combination of the one or more speakers (110), the at least one built-in microphone (112), built-in video camera (114) and the PTT panel (118).

2. The accessory (108) as claimed in claim 1, wherein the computing device (104) is connected to a display device (106) configured to display the captured video footage transmitted to the computing device (104) by the built-in video camera (114).

3. The accessory (108) as claimed in claim 1, comprising a port for connecting an external video camera to the computing device (104) to which the gaming controller (102) is connected.

4. The accessory (108) as claimed in claim 1, wherein the housing (200) accommodates the one or more speakers (110), the at least one in-built microphone (112) and the built-in video camera (114), and wherein the housing (200) has a profile that seamlessly integrates with a shape of the gaming controller (102) to provide unrestricted hand placement when the primary user holds the gaming controller (102).

5. The accessory (108) as claimed in claim 1, wherein the at least one built-in microphone (112) is configured to capture the voice-related audio from the primary user, convert the voice-related audio into electrical signals, and transmit the converted electric signals to the audio transmitter of the gaming controller (102), and wherein
the audio transmitter of the gaming controller (102) is configured to transmit the converted electrical signals to any of the computing device (104) for storage, and a secondary computing device associated with the one or more secondary users.

6. The accessory (108) as claimed in claim 1, wherein the PTT panel (118) is operatively connected to the at least one built-in microphone (112) to control activation of the at least one built-in microphone (112), and operatively connected to the one or more speakers (110) to control generation of the audio from the one or more speakers (110) with reduced volume, upon actuation thereof by the primary user.

7. The accessory (108) as claimed in claim 1, further comprising a serial interface (210) to enable the accessory (108) to be operatively coupled with external devices.

8. The accessory (108) as claimed in claim 1, wherein the housing (200) is adapted to be flush with one or more surfaces of the gaming controller (102), and comprises at least a pair of side portions having any or a combination of curved profiles, convex profiles, and concave profiles adapted to prevent contact with the hands of the primary user, when the user grips palm support regions (402, 404) of the gaming controller (102).

9. The accessory (108) as claimed in claim 8, wherein the housing (200) incorporates an inward design directing away from the palm support regions (402, 404) of the gaming controller (102), to prevent contact with the palm support regions (402, 404), when the gaming controller 102 is held by the primary user.

10. The accessory (108) as claimed in claim 1, further comprising a voice-based processing system configured to enable the primary user to speak verbal commands into the at least one built-in microphone (112), to trigger one or more functions of any of the gaming controller (102) and the computing device (104) based on the verbal commands.
